(19) United States
(12) Patent Application Publication
(10) Pub. No.: US 2006/0164394 A1
(43) Pub. Date: Jul. 27, 2006

(54) Compound optical input device and an upholding pedestal thereof

(75) Inventor: Hsin-Hung Tu, Hsin Chu City (TW)

Correspondence Address: TROXELL LAW OFFICE PLLC, SUITE 1404, 5205 LEESBURG PIKE, FALLS CHURCH, VA, 22041, US

(73) Assignee: AIPTEK INTERNATIONAL INC.

(21) Appl. No.: 11/092,928

(22) Filed: Mar. 30, 2005

(30) Foreign Application Priority Data
Jan. 21, 2005 (TW) 94201240

(51) Int. Cl. G09G 5/08

(52) U.S. Cl. 345/166

(57) ABSTRACT

A compound optical input device provides a pen-type optical mouse an additional function of joystick, which has a pen-type optical mouse and a upholding pedestal. The pen-type optical mouse has a barrel and a head. The head has an image-sensing device mounted therein. The upholding pedestal has a covering body and a sliding part. The covering body is formed with a through hole and a concavity for making the sliding part slide on a top portion of the covering body. The sliding part is formed with a receiving cavity for holding the head of the pen-type optical mouse. The head penetrates through the through hole and movably extends into the covering body.

### BACKGROUND OF THE INVENTION

1. Field of the Invention

The present invention relates in general to a compound optical input device and an upholding pedestal thereof, which is used as an input device of computer peripheral, and especially to an optical input device compounded a function of pen-type optical mouse with a function of an optical joystick, and a upholding pedestal disposed at a bottom of the optical input device for supporting the pen-type optical mouse and enabling the pen-type optical mouse to be an optical joystick.

2. Description of Related Art

To adapt to the development of computer windows interface (graphical user interface, GUI), a moving cursor is an essential requirement in computer operations. The most common device for a moving cursor is a hand-held mouse, and a wireless optical mouse had been developed. However, after holding the hand-held mouse for a long time, a user's hand muscles become stiff and uncomfortable, and may even be injured. Therefore, a pen-type optical mouse has been developed for avoiding discomfort due to operating the hand-held mouse.

The pen-type optical mouse is only used for replacing the original mouse presently. The inventor, after investigation and research, thus provides the present invention of logical design for developing the above-mentioned pen-type optical mouse with more functions.

### SUMMARY OF THE INVENTION

An objective of the present invention is to provide a compound optical input device and an upholding pedestal thereof, which utilizes optical sensing to detect the displacement range, allowing a pen-type optical mouse to serve as a joystick.

Another objective of the present invention is to provide an upholding pedestal of a compound optical input device to make a pen-type optical mouse slide on the upholding pedestal and achieve the function of a joystick, which utilizes optical sensing to detect a displacement range, to increase an additional function. The upholding pedestal also can hold and support the pen-type optical mouse.

In order to achieve the above objectives, the present invention provides a compound optical input device, comprising a pen-type optical mouse and a upholding pedestal. The pen-type optical mouse has a barrel and a head connected to an end of the barrel, and the head has an image-sensing device mounted therein. The upholding pedestal has a covering body and a sliding part. The sliding part is slidably mounted on a top portion of the covering body. The covering body is formed with a through hole. The sliding part is formed with a receiving cavity for holding the head of the pen-type optical mouse. The head penetrates the through hole and is movably extended into the covering body.

The present invention can sense the displacement range of the head by the image-sensing device, and then output a corresponding signal to an electrical device (such as a computer), which makes the optical input device simulate a joystick and provides the pen-type optical mouse with an additional function of joystick.

### BRIEF DESCRIPTION OF THE DRAWINGS

The invention will be better understood and objectives other than those set forth above will become apparent when consideration is given to the following detailed description thereof. Such description makes reference to the attached drawings, wherein:

FIG. 1 is an exploded perspective view of a compound optical input device according to the present invention;

FIG. 2 is an exploded cross-sectional view of a compound optical input device according to the present invention;

FIG. 3 is an assembled cross-sectional view of a compound optical input device according to the present invention;

FIG. 4 is a cross-sectional view of a compound optical input device in an operating condition according to the present invention;

FIG. 5 is a cross-sectional view of a compound optical input device in another operating condition according to the present invention; and

FIG. 6 is a cross-sectional view of a compound optical input device of another embodiment according to the present invention.

### DETAILED DESCRIPTION OF PREFERRED EMBODIMENTS

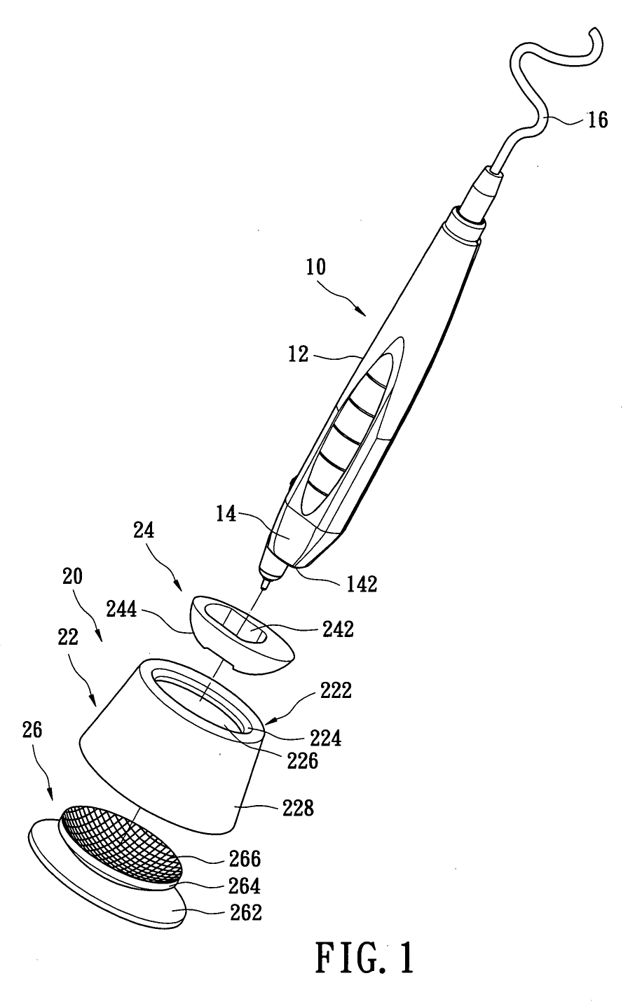

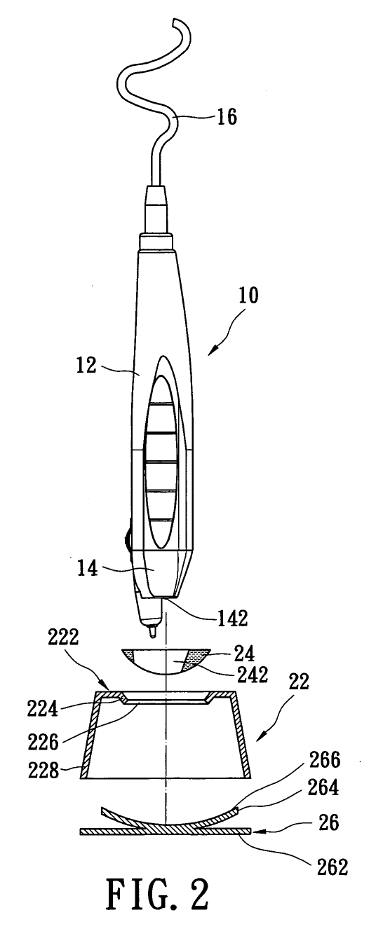

Reference is made to FIGS. 1 and 2, which are exploded perspective and cross-sectional views of a compound optical input device according to the present invention. The present invention provides a compound optical input device, comprising a pen-type optical mouse 110 and an upholding pedestal 20.

The pen-type optical mouse 10 has a barrel 12 and a head 14, and is held like a pen for controlling a cursor on a computer screen. The head 14 is connected to an end of the barrel 12. The barrel 12 is held by a user and contains all necessary electric elements therein. In this embodiment, another end of the barrel 12 connects with a wire 16 for connecting to the computer. An image-sensing device 142 is mounted in the head 14, which can sense displacement of the pen-type optical mouse 10 by detecting changes in an optical image. In greater detail, the image-sensing device 142 includes a light emitting element and a light-receiving element. The light-receiving element can be a CCD (Charge Coupled Device) or a CMOS (Complementary Metal Oxide Semiconductor) for detecting changes of optical image.

The upholding pedestal 20 has a covering body 22 and a sliding part 24. The sliding part 24 is slidably mounted on a top portion 222 of the covering body 22. The top portion 222 of the covering body 22 is formed with a through hole 226. The sliding part 24 is formed with a receiving cavity 242 for holding the head 14 of the pen-type optical mouse 10. The through hole 226 communicates with the receiving cavity 242 and is substantially larger than the receiving cavity 242. The receiving cavity 242 is shaped to match the shape of the head 14 of the pen-type optical mouse 10, and holds the head 14. The head 14 penetrates through the through hole 226 and movably extends into the covering body 22.

In this embodiment, the covering body 22 is formed with an arc shell 224 on the top portion 222 to make the sliding part 24 slidable on the covering body 22. The arc shell 224 is preferably a part of globular shell. The sliding part 24 is formed with an arc bottom 244 corresponding to the arc shell 224 (as shown in FIG. 1), and the through hole 226 is formed in the arc shell 224. Therefore, the sliding part 24 is slidably mounted on the covering body 22. In this embodiment, the through hole 226 of the covering body 22 is preferably circular, and the head 14 of the pen-type optical mouse 10 extending into the covering body 22 therefore can move in each direction.

The covering body 24 has a hollow barrel portion 228 that downwardly extends from a periphery of the top portion 222 of the covering body 24. The barrel portion 228 is gradually wider from top to bottom and is substantially tapered. In this embodiment, the compound optical input device further comprises a base seat 26 disposed under the covering body 24. The base seat 26 has a base board 262 and a testing board 264 formed on the base board 262. A testing surface 266 is formed on a top of the base board 262. The testing surface 266 has a pattern for image recognition. The pattern can be a printed figure, transformed lines, or an adhered figure, or a reflective structure with shadow transformation, which are recognizable for the image-sensing device 142 of the pen-type optical mouse 10.

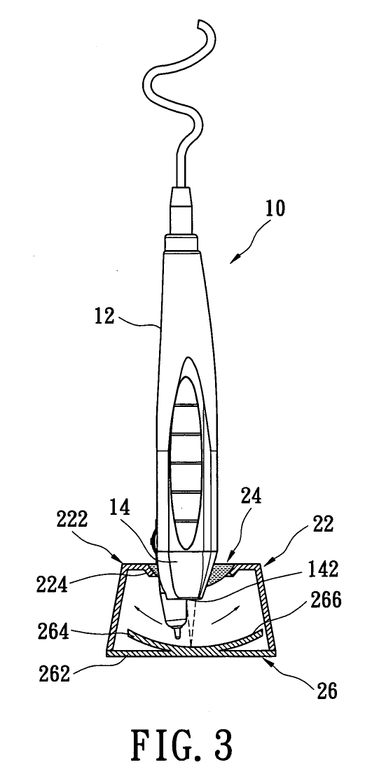

Reference is made to FIG. 3, which is a cross-sectional assembled view of a compound optical input device according to the present invention. The characteristic of the present invention makes the pen-type optical mouse 10 perform not only as a mouse but also as a joystick. By adding the covering body 22, the pen-type optical mouse 10 is upheld, and the integral whole of the compound optical input device can act like a joystick, which utilizes optical sensing to detect the displacement range and performing the function of joystick.

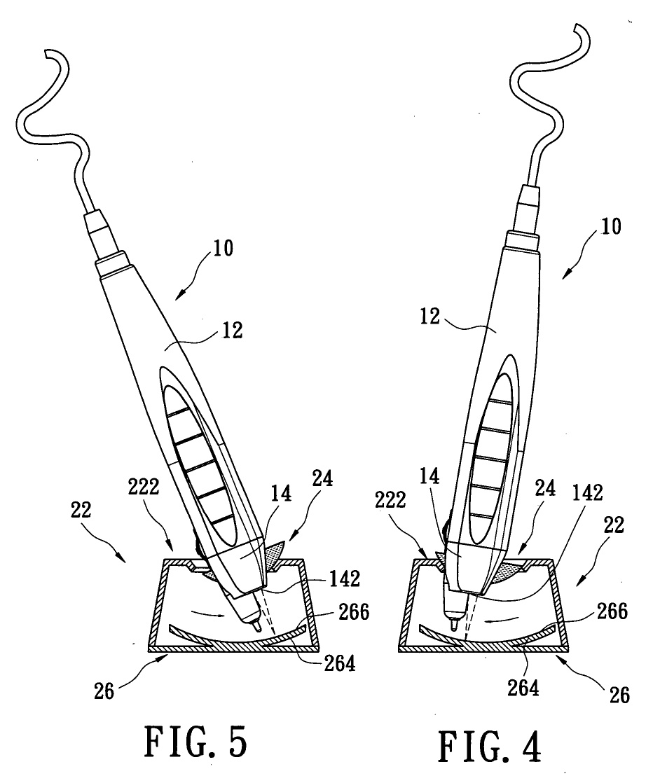

Reference is made to FIGS. 4 and 5, which illustrate different operating situations of the compound optical input device according to the present invention. By holding the barrel 12 of the compound optical input device, the present invention provides a joystick-like mode of operation. Because the sliding part 24 has a top surface larger than the through hole 226 on the top portion of the covering body 22, the sliding part 24 will not fall into the covering body 22, no matter how the sliding part 24 is rotated.

The testing board 264 preferably is formed with a curved surface with radian, which has a constant distance between the image-sensing device 142 of the pen-type optical mouse 10. The preferred embodiment is that the arc shell 224 of the covering body 22, the arc bottom 244 of the sliding part 24 and the testing surface 266 of the testing board 264 are formed with the same curve center, i.e. the same curvature.

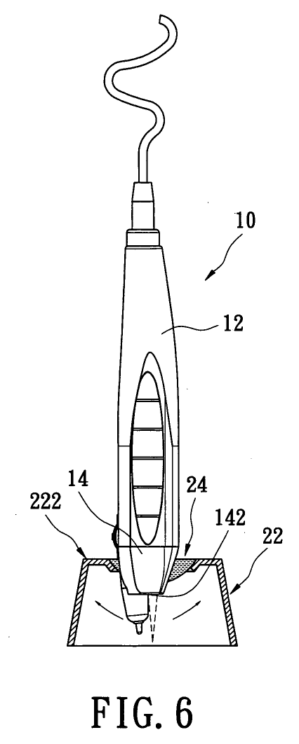

Reference is made to FIG. 6, which is a cross-sectional view of the compound optical input device of second embodiment according to the present invention. The compound optical input device of the present invention can include disposition the covering body 22 on a reflecting surface suitable for image recognition, such as a non-transparent tabletop or a mouse pad. The practicable condition comprises just controlling a depth of field of the image-sensing device 142 of the pen-type optical mouse 10 within an allowable range.

A summary of the characteristics and advantages of the compound optical input device of the present invention are as follows:

1. The compound optical input device of the present invention adds an application for the pen-type optical mouse. Addition of an upholding pedestal, makes the pen-type optical mouse slidable on the upholding pedestal and utilizes optical sensing to detect the displacement range. Therefore, the product can be used as a joystick, and the functions thereof are increased.

2. The upholding pedestal can hold and support the pen-type optical mouse.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A compound optical input device, comprising:
a pen-type optical mouse having a barrel and a head connected to an end of the barrel, the head having an image-sensing device mounted therein; and
an upholding pedestal having a covering body and a sliding part, the sliding part slidably mounted on a top portion of the covering body, the covering body formed with a through hole, the sliding part formed with a receiving cavity for holding the head of the pen-type optical mouse, and the head penetrating the through hole and movably extending into the covering body.

2. The compound optical input device as in claim 1, wherein the covering body is formed with an arc shell on the top portion thereof, the sliding part is formed with an arc bottom corresponding to the arc shell, and the through hole is formed in the arc shell.

3. The compound optical input device as in claim 1, wherein the through hole of the covering body is circular.

4. The compound optical input device as in claim 1, wherein the covering body has a hollow barrel portion downwardly extending from a periphery of the top portion thereof.

5. The compound optical input device as in claim 4, wherein the barrel portion is gradually wider from a top portion to a bottom portion thereof.

6. The compound optical input device as in claim 1, further comprising a base seat disposed under the covering body.

7. The compound optical input device as in claim 6, wherein the base seat has a base board and a testing surface formed on a top of the base board, and the testing surface has a pattern for image recognition.

8. An upholding pedestal, for holding a pen-type optical mouse, comprising:
a covering body having a top portion, the top portion formed with a through hole; and
a sliding part slidably mounted on the top portion of the covering body, the sliding part formed with a receiving cavity for holding a head of the pen-type optical mouse, the head penetrating through the through hole of the covering body and movably extending into the covering body.

9. The upholding pedestal as in claim 8, wherein the covering body is formed with an arc shell on the top portion thereof, and the sliding part is formed with an arc bottom corresponding to the arc shell, and wherein the through hole is formed on the arc shell.

10. The upholding pedestal as in claim 8, wherein the through hole of the covering body is circular.

11. The upholding pedestal as in claim 8, wherein the covering body has a hollow barrel portion downwardly extending from a periphery of the top portion thereof, the barrel portion is gradually wider from a top portion to a bottom portion thereof and is substantially taper-shaped.

12. The upholding pedestal as in claim 8, further comprising a base seat disposed under the covering body.

13. The upholding pedestal as in claim 12, wherein the base seat has a base board and a testing surface formed on a top of the base board, and the testing surface has a pattern for image recognition.
